(19) United States
(12) Patent Application Publication
(10) Pub. No.: US 2003/0137544 A1
(43) Pub. Date: Jul. 24, 2003

(54) Information service

(76) Inventors: John William Mears, Bow Brickhill (GB); Richard John Patterson, Linden Village (GB)

Correspondence Address: Gottlieb Rackman & Reisman, 270 Madison Avenue, New York, NY, 10016-0601, US

(21) Appl. No.: 10/203,305

(22) PCT Filed: Jan. 31, 2001
(86) PCT No.: PCT/GB01/00397

(30) Foreign Application Priority Data
Feb. 8, 2000 (GB) 0002875.3

(51) Int. Cl. G09G 5/00

(52) U.S. Cl. 345/810

(57) ABSTRACT

A web page provides users with a number of options for accessing help information over the internet relating to the use of desktop software. The options include help by e-mail, via an internet chat session, via voice-over-IP, via a conventional telephone line and through searching a knowledge database. Users can choose the type of help they feel will be most appropriate to their particular problem by clicking on the icon which represents their preferred option. The user request is passed to an intelligent router which treats all internet requests in the same way and routes the request to the most appropriate person to deal with the particular request, based on a predetermined set of rules.

### FIELD OF THE INVENTION

The present invention lies in the field of information services, and is particularly but not exclusively directed to using a client-server system for providing help facilities to users of desktop software applications.

### BACKGROUND

The recent explosion in computer use and the continuing proliferation of increasingly powerful software has brought with it its own problems, particularly in the business context where efficient use of software is of paramount concern. As applications have become more powerful, so they have become more complex, with allegedly intuitive user interfaces being unable to provide the average user with sufficient information to use a particular software package effectively. The trend towards dispensing with user manuals and providing an on-line help file has not alleviated the problems, since both user manuals and on-line help files can be difficult to use and often fail to quickly address the specific problem which the user is experiencing.

Occasionally, help is available from a telephone information line provided by the software developer or provider or by e-mailing the provider or an organisation which supports the particular software package. However, a user will typically regularly use a number of different software packages, and will therefore have to seek assistance from a number of different providers. The development of the Internet has provided other means for users to obtain assistance, for example, fora such as newsgroups. Nevertheless, all of the above described methods of seeking help are time consuming and the user may have to go through a large number of sources before finding help for his particular problem.

### SUMMARY OF THE INVENTION

To obviate the above problems, the present invention provides a method of providing information to a user over a telecommunications link in response to a user request, comprising providing a plurality of user selectable options for display to the user, each of said options relating to a different respective method of requesting information, said plurality of options including an option to request information by e-mail, an option to request information over a voice data link and an option to request information over a telephone link, the method further comprising receiving the user request at a common routing node irrespective of the option selected by the user, and providing a response to the user request in accordance with the option selected by the user.

Advantageously, the user has instant access to a collection of different ways of accessing help information and can choose the support method which suits him or her best, depending on the user's particular circumstances and requirements. Furthermore, the user can be provided with access to a single source of information for all of the software packages supported by the information provider.

The response to the user request can be provided by generating an automatic response. Alternatively, a plurality of possible responses can be generated for selection of a correct response by the information provider.

The method can include the step of routing the user request to an information provider in accordance with the option selected by the user. The user request can be routed in accordance with predetermined criteria, such as operating conditions, for example, information provider availability or stored information relating to previous requests made by the same user.

The user can also be provided with an option to request a knowledge database search, and the resulting request can be routed directly to the knowledge database separately from the common routing node. Alternatively, the request can be routed to the common routing node which is configured to pass the request to the knowledge database.

According to the invention, there is further provided a server for providing an information service to a client in a client-server configuration, comprising means for providing a plurality of user selectable options for display to the user, each of said options relating to a different respective method of requesting information, said plurality of options including an option to request information by e-mail, an option to request information over a voice data link and an option to request information over a telephone link, common routing means for receiving the user request irrespective of the option selected by the user, and means for providing a response to the user request in accordance with the option selected by the user.

### BRIEF DESCRIPTION OF THE DRAWINGS

Embodiments of the invention will now be described, by way of example, with reference to the accompanying drawings, in which:

FIG. 1 is an illustration of the home page of the information service web site as viewed using a web browser;

FIG. 2 is a schematic diagram showing a client-server system according to the invention; and

FIG. 3 is a schematic flow diagram illustrating the operation of the client-server system of FIG. 2.

### DETAILED DESCRIPTION

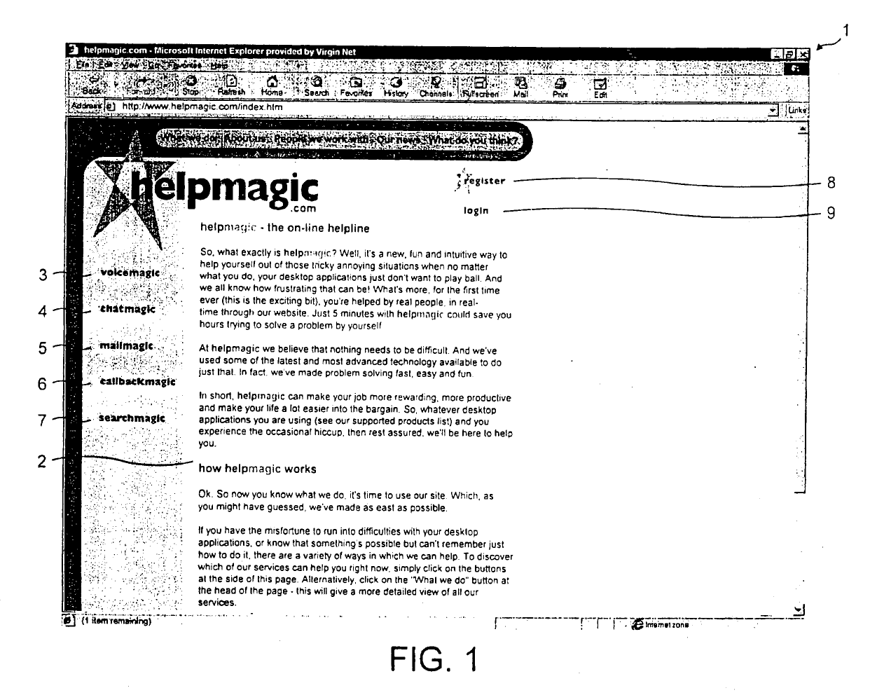

Referring to FIG. 1, access to an information service according to the invention is provided, for example, through an Internet web site 1. The web site includes text 2 which explains the site and its facilities to a user accessing the site. The web site also includes a number of icons 3-7 which are associated with options available to the user and which are referred to herein as ‘voicemagic’ 3, ‘chatmagic’ 4, ‘mailmagic’ 5, ‘callbackmagic’ 6 and ‘searchmagic’ 7 options. The user can access these options by initially registering with the site through the register icon 8, and subsequently logging in through the login icon 9 every time he or she wishes to use the service, using a user name and password assigned during the registration procedure. The registration procedure is concerned with, for example, obtaining the user's name, address and contact details, as well as payment details such as a credit card number. The user selectable options are explained in more detail below.

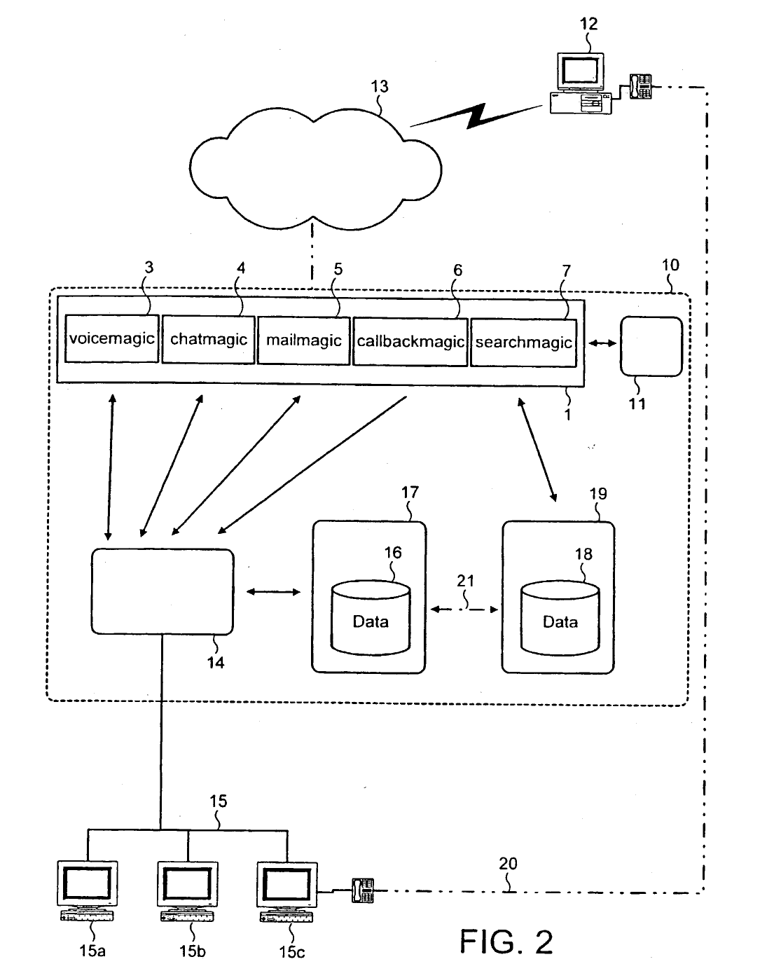

Referring to FIG. 2, a client-server system according to the invention comprises a server machine 10, for example, a Windows NT™ server running a number of server applications, including a web server application 11, for example, the Microsoft IIS™ web server, which supports the web site 1. A user 12 can log-in to the web site via, for example, the Internet 13, using a web client such as the Microsoft Internet Explorer™ browser. The server 10 further comprises an intelligent router 14 which routes information to and from a plurality of information provider agents 15 in accordance with predetermined rules stored in a database 16, via a database server application 17, for example, an SQL server, as is well known in the art. The agents 15 are, for example, human operators located at a help centre. Agents can also be computers providing automated responses to particular requests. The router 14 can also provide automated responses to, for example, e-mail requests, as described in more detail below. The functionality of the intelligent router 14 can be implemented by, for example, the Genesys Internet Contact Center solution, from Genesys Telecommunications Laboratories Inc., which provides support for a variety of Internet based communication channels.

The server 10 further comprises a knowledge database 18 supported by, for example, an SQL database server application 19. A suitable knowledge database is the Knowledge-Pak Desktop Suite from ServiceWare, Inc.

The operation of the client-server system shown in FIG. 2 is described in more detail below.

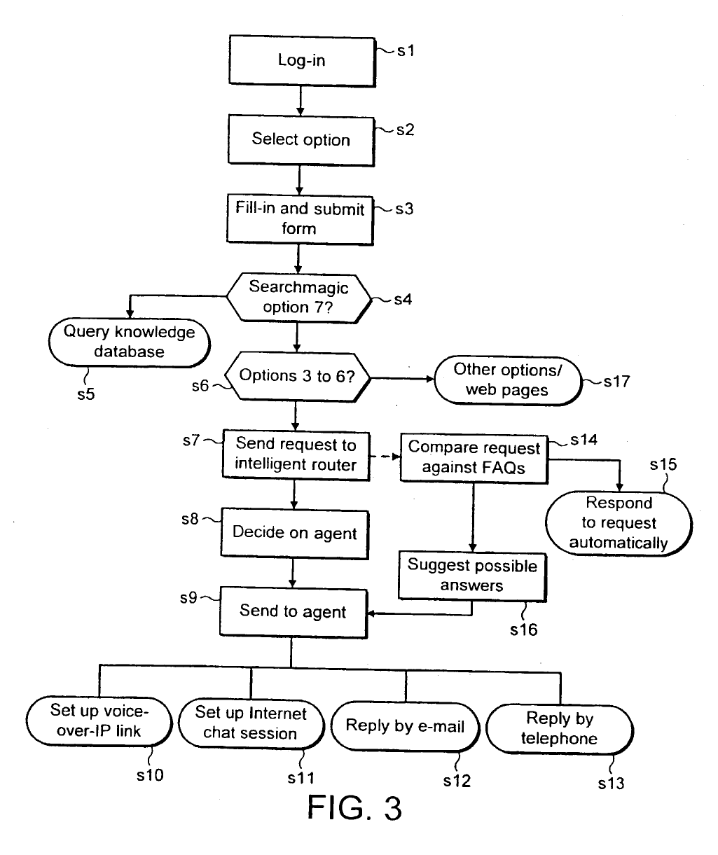

Referring to FIGS. 1 to 3, a user 12 logs on to the web site 1 via the log-in function 9 (step s1). He or she then selects one of the ‘magic’ options 3 to 7 specifying how help is to be provided (step s2). Clicking on an option will provide the user with a web page which displays an on-line form to be filled in detailing the nature of the user's problem and information relevant to the user's request for help. For example, in the case of the user selecting the callbackmagic option 6, the form includes questions regarding the time at which the user would like to be called back.

The user fills in the form and clicks on a ‘Submit’ button (step s3) which sends the relevant information to the server 10. In the event that the ‘searchmagic’ option 7 is selected (step s4), then the user's request is converted into the series of SQL commands which are used to query the knowledge database 18 directly (step s5). If one of the other options 3-6 is selected (step s6), the user's request is sent to the intelligent router 14 (step s7) irrespective of the type of request. The intelligent router 14 therefore acts as a common reception point or node for all such requests and decides which of the agents 15 the request is to be sent to (step s8). For example, the intelligent router 14 can be set to always route e-mail requests through to one agent 15a, and can be configured to consult the rules database 16 to decide on which agent the request should be sent to. For example, if a particular user has built up a relationship with one particular agent, this information can be stored in the database 16; on future occasions, this user is preferentially routed to that agent.

The rules can be established to route a request to an agent depending on a variety of other factors including agent availability, system capacity or information relating to particular skills possessed by particular agents. Once an agent 15 is allocated, the request is sent to that agent (step s9) and the agent deals with the request in the appropriate manner. For example, if the request is for a voice data link, ie. the voicemagic option 3, then the agent sets up a voice-over-IP (Internet Protocol) connection using, for example, Microsoft NetMeeting™ (step s10). If the user has selected the chatmagic 4 option, the agent 15 sets up an Internet chat session which enables real-time text communication between an agent and the user (step s11). If the user has selected the mailmagic 5 option, the request includes the user's query and the agent 15 answers the query by e-mailing the user (step s12). If the user initiates a callbackmagic 6 request, an agent 15c will call the user back over a conventional telephone link 20 to discuss the problem (step s13).

Alternatively or in addition to the above features, the router 14 can also be configured to respond to requests automatically, without going through an agent 15. For example, the router 14 compares an e-mail request against a list of frequently asked questions (FAQs) in the rules database 16 (step s14). If a complete match is found, the router 14 responds to the user automatically on the basis of a stored answer (step s15). If an incomplete match is found, the router can be configured to suggest a number of possible answers (step s16) which can then be sent with the request to an agent in the normal way (step s9), to assist the agent with responding to the user's request. In a further embodiment, an interface 21 exists between the rules database 16 and the knowledge database 18 to permit more sophisticated automatic response facilities based on a search of the knowledge database 18.

The user can of course click on icons on the web page other than the ‘magic’ options set out above, to go to other web pages which provide, for example, more information about the service provider (step s17).

In a yet further alternative embodiment of the invention, referring to FIG. 2, the searchmagic option 7 is also routed through the intelligent router 14, which is configured to send all search requests directly to the knowledge database 18, rather than to the agents 15.

It will be understood that the various embodiments described above are not mutually exclusive, and a person skilled in the art would readily combine features in different embodiments to achieve a desired configuration.

While the above examples have been based on the Internet and access via web pages, the invention is not limited to this type of access, but covers all forms of Internet Protocol based network and indeed networks based on other types of protocol which provide the necessary facilities, for example to establish a voice-over-data network link.

Furthermore, while the invention has been described in relation to a help centre facility for desktop software users, it will be understood that the information service described is applicable to many different situations. For example, in the context of internet shopping, it has been found that a significant proportion of users give up when they encounter any difficulties with ordering goods over a web site. The provision of an information service to enable them to ask questions in a format with which such users, who may be very new to the Internet, feel comfortable, can significantly improve site usage.

1. A method of providing information to a user over a telecommunications link in response to a user request, comprising:
providing a plurality of user selectable options for display to the user, each of said options relating to a different respective method of requesting information,
said plurality of options including an option to request information by e-mail, an option to request information over a voice data link and an option to request information over a telephone link, the method further comprising:
receiving the user request at a common routing node irrespective of the option selected by the user; and
providing a response to the user request in accordance with the option selected by the user.

2. A method according to claim 1, wherein the step of providing the response to the user request comprises generating an automatic response.

3. A method according to claim 1 or 2, including the step of routing the user request to an information provider in accordance with the option selected by the user.

4. A method according to claim 3, further comprising generating a plurality of possible responses for routing to the information provider.

5. A method according to claim 4, including routing the request to an information provider together with the plurality of possible responses, to facilitate selection of the correct response to the user request.

6. A method according to claim 3, 4 or 5, including routing the request in accordance with predetermined criteria.

7. A method according to claim 6, wherein the predetermined criteria include information relating to previous requests made by the user.

8. A method according to any one of the preceding claims, wherein the user selectable options further include an option to permit real time text communications over a data network.

9. A method according to any one of the preceding claims, further comprising providing the user with an option to request a knowledge database search.

10. A method according to claim 9, comprising receiving a request for a knowledge database search at a node separate from the common routing node.

11. A method according to claim 9, comprising receiving a request for a knowledge database search at the common routing node and routing said request to the knowledge database.

12. A method according to any one of the preceding claims, comprising receiving user requests via the Internet.

13. A server for providing an information service to a client in a client-server configuration, comprising:
means for providing a plurality of user selectable options for display to the user, each of said options relating to a different respective method of requesting information, said plurality of options including an option to request information by e-mail, an option to request information over a voice data link and an option to request information over a telephone link;
common routing means for receiving the user request irrespective of the option selected by the user; and
means for providing a response to the user request in accordance with the option selected by the user.

14. A server according to claim 13, wherein the routing means is configured to provide an automatic response to the user request.

15. A server according to claim 13 or 14, wherein the routing means is configured to route the request to an information provider in accordance with the option selected by the user.

16. A server according to claim 13, 14 or 15 further comprising a database for providing a knowledge based information service to the user.
